(19) United States
(12) Patent Application Publication
(10) Pub. No.: US 2004/0252766 A1
(43) Pub. Date: Dec. 16, 2004

(54) Motion vector search method and apparatus

(75) Inventors: Yung-Lyul Lee, Seoul (KR); Hyun Cho, Seoul (KR)

Correspondence Address: STAAS & HALSEY LLP, SUITE 700, 1201 NEW YORK AVENUE, N.W., WASHINGTON, DC, 20005, US

(73) Assignees: Daeyang Foundation (Sejong University), Seoul (KR); Samsung Electronics Co., Ltd., Suwon-si (KR)

(21) Appl. No.: 10/864,329

(22) Filed: Jun. 10, 2004

(30) Foreign Application Priority Data
Jun. 11, 2003 (KR) 2003-37334
Dec. 18, 2003 (KR) 2003-93162

(51) Int. Cl. H04N 7/12

(52) U.S. Cl. 375/240.17; 348/699; 375/240.16

(57) ABSTRACT

A motion vector (MV) search method including: searching for an integer-pixel MV among integer pixels and choosing an integer pixel corresponding to the integer-pixel MV; searching for a half-pixel MV among half pixels around the chosen integer pixel and choosing a half pixel corresponding to the half-pixel MV; and searching, when the half pixel is chosen, for a quarter-pixel MV among only specified quarter pixels disposed between the chosen integer pixel and the chosen half pixel and around the chosen half pixel and choosing a quarter pixel corresponding to the quarter-pixel MV.

### CROSS-REFERENCE TO RELATED APPLICATIONS

This application claims the priorities of Korean Patent Application Nos. 2003-37334, filed on Jun. 11, 2003, and 2003-93162, filed on Dec. 18, 2003, in the Korean Intellectual Property Office, the disclosures of which are hereby incorporated by reference in their entireties.

### BACKGROUND OF THE INVENTION

1. Field of the Invention

The present invention relates to motion vector (MV) search, and more particularly, to an MV search method and an apparatus in which the amount of quarter-pixel MV searching is reduced.

2. Description of Related Art

Conventionally, most image compression standards use block-based motion estimation (ME) and motion compensation (MC). ME plays a critical role in reducing a bit rate by exploiting temporal redundancy in moving picture encoding, but requires a considerable amount of computation.

To reduce computation time in encoders, several ME algorithms such as a three-step search, a 2-D logarithm search, a one-at-a-time search (OTS), and a new diamond search have been proposed. In these algorithms, MVs are searched in integer pixel units using about 3-5% of the computation required for a full search algorithm by reducing the number of search points. However, such algorithms tend to fall in a local minimum, and do not have a peak signal to noise ratio (PSNR) as high as a full search algorithm.

A hierarchical successive elimination algorithm (SEA) is a fast ME technique proposed to solve the above problems. In the hierarchical SEA, unnecessary candidate blocks are eliminated using the fact that the sum of absolute difference (SAD) between a specific block of a current frame and a candidate block of a previous frame is greater than or equal to the absolute sum of the differences between the two blocks. Thus, the hierarchical SEA makes a fast full search possible, using only 13% of the computation required for a full search algorithm while maintaining search performance that is the same as the full search algorithm.

Also, methods of searching a candidate block of a reference image frame using a block of a current image frame include a spiral full search algorithm and a fast full search algorithm. The spiral full search algorithm performs ME on a region of ±16 pixels neighboring an MV obtained from adjacent blocks by central prediction in a spiral fashion. The fast full search computes SAD of sixteen 4×4 blocks for each macroblock (MB) on a ±16 pixel radius and obtains SAD of hierarchically higher-order blocks using the computed SAD, thereby performing ME. It is desirable to select a previous image frame having a high correlation with the current image frame as the reference image frame.

In ITU-T recommendation H.264, which is a moving picture compression/decompression technique, most of the computation is performed during variable block-based ME and MC and interpolation with quarter-pixel accuracy, and a considerable amount of time is spent in searching MVs of up to quarter pixels.

### BRIEF SUMMARY

The present invention provides an MV search method that requires a reduced amount of computation without affecting display quality by obtaining the best half-pixel MV from among eight half pixels neighboring a found integer pixel and only searching for a quarter-pixel MV among quarter pixels around the obtained half pixel in the quarter-pixel MV search.

The present invention also provides an MV search method and apparatus which reduces the amount of searching by only searching for a quarter-pixel MV only among specified quarter pixels using a chosen integer pixel and a predicted MV (PMV).

According to one aspect of the present invention, there is provided a motion vector (MV) search method including: searching for an integer-pixel MV among integer pixels and choosing an integer pixel corresponding to the integer-pixel MV; searching for a half-pixel MV among half pixels around the chosen integer pixel and choosing a half pixel corresponding to the half-pixel MV; and searching, when the half pixel is chosen, for a quarter-pixel MV among only specified quarter pixels disposed between the chosen integer pixel and the chosen half pixel and around the chosen half pixel and choosing a quarter pixel corresponding to the quarter-pixel MV..

According to another aspect of the present invention, there is provided a motion vector (MV) search method including: searching for an integer-pixel MV among integer pixels and choosing an integer pixel corresponding to the integer pixel MV; searching for a half-pixel MV among half pixels around the chosen integer pixel and choosing a half pixel corresponding to the half-pixel MV; and searching, when the half pixel is chosen, for a quarter-pixel MV among only quarter pixels disposed on a line connecting the chosen half pixel to the chosen integer pixel and choosing a quarter pixel corresponding to the quarter-pixel MV.

The MV search method may also include searching for the quarter-pixel MV among the determined quarter pixel and quarter pixels disposed on a line orthogonal to the line which connects the chosen half pixel and the chosen quarter pixel and choosing a quarter pixel corresponding to the quarter-pixel MV.

According to still another aspect of the present invention, there is provided a motion vector (MV) search method including: searching for an integer-pixel MV among integer pixels and choosing an optimal integer pixel having a minimum sum of absolute differences (SAD) and a candidate integer pixel having a second-lowest SAD; computing a median value of MVs of a current macroblock (MB) and adjacent MBs adjacent to the current MB and computing a predicted MV (PMV); and searching, when a pixel corresponding to the computed PMV is identical to the chosen integer pixel, for a quarter-pixel MV among quarter pixels disposed between the optimal integer pixel and the candidate integer pixel and choosing a quarter pixel corresponding to the quarter-pixel MV. The SADs are computed by summing absolute differences between pixel values of a current frame and a previous frame.

The MV search method may also include: searching, when the pixel corresponding to the computed PMV is not identical to the optimal integer pixel, for a half-pixel MV among half pixels disposed between the optimal integer pixel and the candidate integer pixel and choosing the half pixel; and searching for a quarter-pixel MV among only quarter pixels disposed in the direction toward integer pixels from among quarter pixels neighboring the chosen half pixel and choosing the quarter pixel.

According to yet another aspect of the present invention, there is provided a motion vector (MV) search apparatus including: an integer pixel search unit, which searches for an integer-pixel MV among integer pixels and chooses an integer pixel corresponding to the integer-pixel MV; a half pixel search unit, which searches for a half-pixel MV among half pixels neighboring the chosen integer pixel and chooses an integer pixel corresponding to the integer-pixel MV; and a quarter pixel search unit, which searches for a quarter-pixel MV among only quarter pixels disposed on a line which connects the chosen half pixel and the chosen integer pixel and chooses a quarter pixel corresponding to the quarter-pixel MV, when the half pixel is chosen.

The quarter pixel search unit may search for the quarter-pixel MV among the chosen quarter pixel and quarter pixels disposed on a line orthogonal to the line which connects the chosen integer pixel and the chosen half pixel and chooses the quarter pixel.

According to still another aspect of the present invention, there is provided a computer readable storage medium encoded with processing instructions for causing a computer to perform a motion vector (MV) search method including: searching for an integer-pixel MV among integer pixels and choosing an integer pixel corresponding to the integer-pixel MV; searching for a half-pixel MV among half pixels around the chosen integer pixel and choosing a half pixel corresponding to the half-pixel MV; and searching, when the half pixel is chosen, for a quarter-pixel MV among only specified quarter pixels disposed between the chosen integer pixel and the chosen half pixel and around the chosen half pixel and choosing a quarter pixel corresponding to the quarter-pixel MV.

According to still another aspect of the present invention, there is provided a computer readable storage medium encoded with processing instructions for causing a computer to perform a motion vector (MV) search method including: searching for an integer-pixel MV among integer pixels and choosing an integer pixel corresponding to the integer pixel MV; searching for a half-pixel MV among half pixels around the chosen integer pixel and choosing a half pixel corresponding to the half-pixel MV; and searching, when the half pixel is chosen, for a quarter-pixel MV among only quarter pixels disposed on a line connecting the chosen half pixel to the chosen integer pixel and choosing a quarter pixel corresponding to the quarter-pixel MV.

According to still another aspect of the present invention, there is provided a computer readable storage medium encoded with processing instructions for causing a computer to perform a motion vector (MV) search method including: searching for an integer-pixel MV among integer pixels and choosing an optimal integer pixel having a minimum sum of absolute differences (SAD) and a candidate integer pixel having a second-lowest SAD; computing a median value of MVs of a current macroblock (MB) and adjacent MBs adjacent to the current MB and computing a predicted MV (PMV); and searching, when a pixel corresponding to the computed PMV is identical to the chosen integer pixel, for a quarter-pixel MV among quarter pixels disposed between the optimal integer pixel and the candidate integer pixel and choosing a quarter pixel corresponding to the quarter-pixel MV. The SADs are computed by summing absolute differences between pixel values of a current frame and a previous frame.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1A is a view for explaining a quarter pixel search method according to a first embodiment of the present invention;

FIG. 1B is a view for explaining determination of half-pixels and quarter-pixels;

FIG. 2 is a view for explaining a quarter pixel search method according to a second embodiment of the present invention;

FIG. 3 is a view for explaining a quarter pixel search method according to a third embodiment of the present invention;

FIG. 4 is a view for explaining computation of a PMV usable in the third embodiment; and

FIG. 5 is a block diagram of an MV search apparatus according to a fourth embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

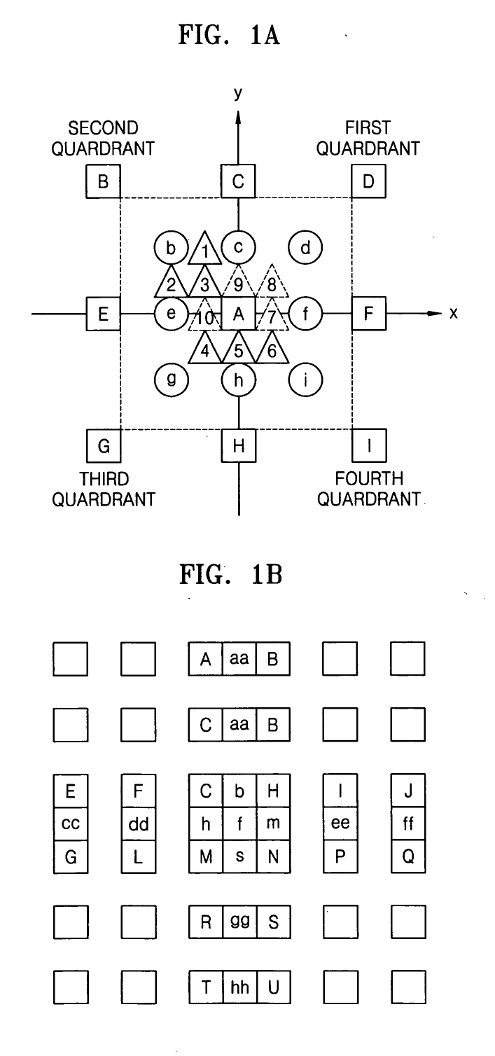

FIG. 1A is a view for explaining a quarter pixel search method according to a first embodiment of the present invention.

Referring to FIG. 1A, capital letters in squares represent integer pixels, small letters in circles represent half pixels, and numbers in triangles represent quarter pixels.

First, an integer-pixel MV is searched for to determine an integer pixel corresponding to the integer MV. If a pixel A is determined to be the integer pixel in the integer-pixel MV search, a pixel having the minimum SAD, i.e., a half pixel corresponding to a half-pixel MV, is chosen from among eight half pixels b, c, d, e, f, g, h, and i neighboring the pixel A. SAD is computed by summing the absolute differences between the pixel values of a current frame and a previous frame.

Next, a quarter-pixel MV is searched for among quarter pixels neighboring the chosen half pixel. Conventionally, to search for a quarter-pixel MV, SADs of eight neighbor quarter pixels around a half pixel are computed. However, in the present embodiment, a quarter pixel is chosen by computing SADs of only three quarter pixels that are closest to a specified integer pixel of eight quarter pixels neighboring a half pixel and comparing the computed SADs.

For example, if the chosen half pixel is b, only quarter pixels 1, 2, and 3 are investigated. If the found half pixel is h, only quarter pixels 4, 5, and 6 are investigated.

Only some of the quarter pixels are searched because the optimal quarter pixel is likely to be located between the optimal integer pixel and the optimal half pixel. In fact, when only three quarter pixels were searched, computation speed improved while rate-distortion performance was not degraded in comparison with other methods.

This occurs when the minimum SAD among half pixels is smaller than the minimum SAD among integer pixels. However, when the minimum SAD among half pixels is larger than the minimum SAD among integer pixels, an integer pixel should be determined to be an MV instead of a half pixel.

For example, if the minimum SAD among eight half pixels neighboring the pixel A is larger than the SAD of the pixel A, the half-pixel MV is determined to be an MV of the pixel A. In this case, in a quarter-pixel MV search, eight quarter pixels 3, 4, 5, 6, 7, 8, 9, and 10 around the pixel A are searched.

FIG. 1B is a view for explaining determination of half pixels and quarter pixels.

Methods of determining a half-pixel and a quarter pixel are defined in ITU-T Recommendation H.264. In FIG. 1B, capital letters represent integer pixels and small letters represent half pixels, and some of the half pixels are determined by a 6-tap finite impulse response filter. For example, if filter weights are 1/32, −5/32, 5/8, 5/8, −5/32, and 1/32, a half pixel b is calculated from 6 integer pixels by b=round ((E−5F+20G+20H−5J+J)/32). The other half pixels can be determined in a similar way. Also, if a quarter pixel a (not shown) is assumed to be present between G and b, it can be determined by a=round ((G+b)/2).

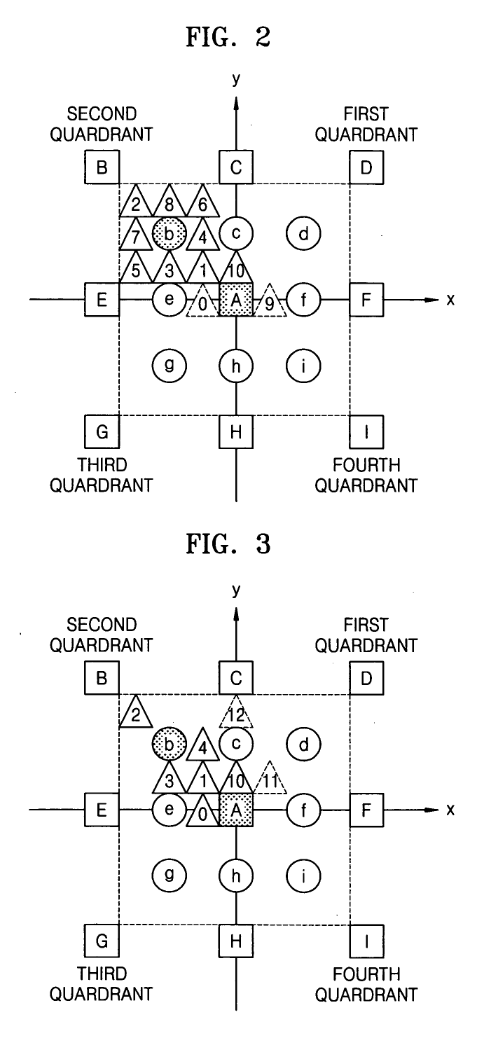

FIG. 2 is a view for explaining a quarter pixel search method according to a second embodiment of the present invention.

In FIG. 1, capital letters in squares represent integer pixels, small letters in circles represent half pixels, and numbers in triangles represent quarter pixels. Such denotation is also applied to FIG. 3.

First, an integer MV is searched for to determine an integer pixel corresponding to the integer MV. If a pixel A is determined to be the integer pixel found in the integer MV search, a pixel having the minimum SAD, i.e., a half pixel corresponding to a half MV, is chosen from among eight half pixels b, c, d, e, f, g, h, and i neighboring the pixel A. SAD is computed by summing the absolute differences between the pixel values of a current frame and a previous frame.

Next, a quarter-pixel MV is searched for among quarter pixels neighboring the chosen half pixel. The quarter-pixel MV is determined by computing the SADs of only 2 quarter-pixels disposed on a line that connects the chosen half pixel and the pixel A and comparing the computed SADs. In other words, a quarter pixel having the smaller SAD is determined to be the quarter MV. Based on the determined quarter pixel, 2 quarter pixels disposed on a line orthogonal to the line that connects the chosen half pixel and the pixel A are additionally selected, the SADs of the selected 2 quarter pixels are computed, and one quarter pixel is chosen.

For example, if the chosen half pixel is b, only pixels 1 and 2 disposed on a line that connects the pixel A and the pixel b are investigated. On the other hand, if the pixel b has the minimum SAD, pixels 5 and 6 are further investigated. As a result of investigation, if pixel 1 has the minimum SAD, pixels 7 and 8 are further investigated. In this way, one quarter-pixel is determined.

According to the method described above, the total number of search points is equal to the sum of 8 (half pixels) and 4 (quarter pixels), i.e., 12. Therefore, the amount of computation is greatly reduced.

FIG. 3 is a view for explaining a quarter pixel search method according to a third embodiment of the present invention.

An MV search method to be described with reference to FIG. 3 further reduces the amount of searching using PMV information in addition to the search method described with reference to FIG. 2. First, an integer MV is searched for to determine an integer pixel corresponding to the integer MV. At this time, the optimal integer pixel and a candidate integer pixel are determined. In other words, a pixel having the minimum SAD is determined to be the optimal integer pixel and a pixel having the second-lowest SAD is determined to be the candidate integer pixel.

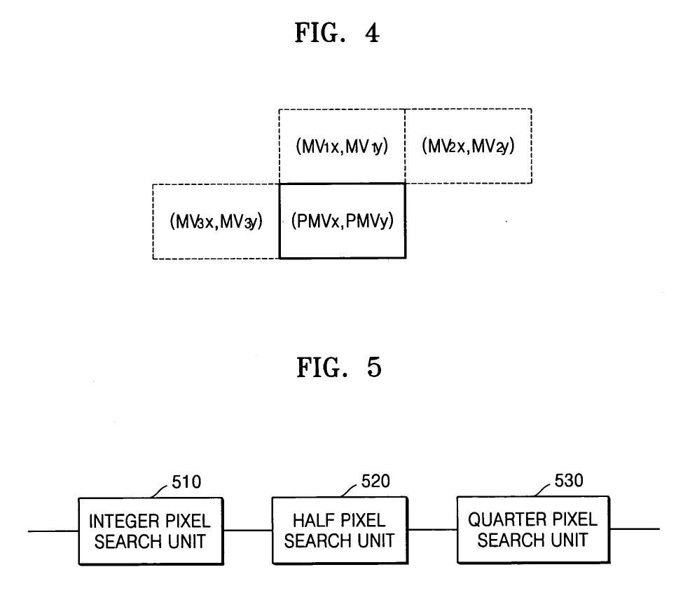

Then the PMV of a current macroblock (MB) is computed. Computation of the PMV is described with reference to FIG. 4.

FIG. 4 is a view for explaining computation of the PMV.

Referring to FIG. 4, the PMV of the current MB is determined based on MVs of adjacent MBs. PMVx of the current MB is computed by performing a median of MV1x, MV2x, and MV3x, and PMVy is computed by performing a median of MV1y, MV2y, and MV3y.

Hereinafter, in the integer-pixel MV search, assuming that a reference integer pixel corresponding to an integer-pixel MV is a pixel A and a candidate integer pixel is a pixel B, cases where a pixel corresponding to the computed PMV is A and is not A will be described separately.

If the pixel corresponding to the computed PMV is A, a quarter MV is searched for among the quarter pixels 0, 1, and 10 disposed in the direction toward the candidate integer pixel B and neighboring the integer pixel A. The quarter pixel having the minimum SAD is selected as an MV. Thus, in this case, only a total of 3 search points are investigated. On the other hand, if the pixel corresponding to the computed PMV is not A, a half MV is searched for among the half-pixels b, c, and e disposed in the direction toward the candidate integer pixel B closest to the integer pixel A. As a result of the search, if the pixel b has the minimum SAD, only quarter pixels 1, 3, 4, and 2 are investigated. If the pixel c has the minimum SAD, a quarter-pixel MV is searched for among the quarter pixels 1, 10, 11, and 12. If the pixel e has the minimum SAD, a quarter-pixel MV is searched for among the quarter pixels 1, 0, 13, and 14. Then the quarter pixel having the minimum SAD is selected as an MV. Thus, in this case, a total of 7 search points are investigated.

FIG. 5 is a block diagram of an MV search apparatus according to a fourth embodiment of the present invention.

The MV search apparatus includes an integer-pixel search unit 510, a half-pixel search unit 520, and a quarter-pixel search unit 530. The integer-pixel search unit 510 searches for an integer-pixel MV as described with reference to FIGS. 1A through 4. The half pixel search unit 520 searches for a half-pixel MV around an integer pixel corresponding to the integer-pixel MV chosen by the integer pixel search unit 510. If the half-pixel MV is found, the quarter pixel search unit 530 chooses a quarter pixel by investigating only quarter pixels disposed on a line that connects the half pixel chosen by the half pixel search unit 520 and the integer pixel chosen by the integer pixel search unit 510 and chooses an MV by further investigating quarter pixels disposed on a line orthogonal to the line that connects the chosen half pixel and the chosen integer pixel.

The quarter pixel search unit 530 can search for the quarter-pixel MV and determine the MV according to whether the integer pixel found by the integer pixel search unit 510 is identical to the integer pixel corresponding to the PMV based on the PMV of the current MB.

The MV search method may be embodied as a computer program. Codes and code segments that constitute the computer program can be deduced by computer programmers skilled in the art. Also, the computer program is stored in computer readable media and the MV search method is implemented by reading and executing the computer program using a computer. The computer readable media includes recording media, optical recording media, and carrier wave media.

As described above, according to the disclosed embodiments of the present invention, a quarter MV is searched for only among quarter pixels disposed between integer pixels and half pixels, thereby reducing the amount of computation and thus improving computation speed.

Although a few embodiments of the present invention have been shown and described, the present invention is not limited to the described embodiments. Instead, it would be appreciated by those skilled in the art that changes may be made in these embodiments without departing from the principles and spirit of the invention, the scope of which is defined by the claims and their equivalents.

What is claimed is:

1. A motion vector (MV) search method comprising:
searching for an integer-pixel MV among integer pixels and choosing an integer pixel corresponding to the integer-pixel MV;
searching for a half-pixel MV among half pixels around the chosen integer pixel and choosing a half pixel corresponding to the half-pixel MV; and
searching, when the half pixel is chosen, for a quarter-pixel MV among only specified quarter pixels disposed between the chosen integer pixel and the chosen half pixel and around the chosen half pixel and choosing a quarter pixel corresponding to the quarter-pixel MV.

2. The MV search method of claim 1, wherein, in the searching for a quarter-pixel MV, the specified quarter pixels are three quarter pixels that are closest to the chosen integer pixel.

3. The MV search method of claim 1, wherein in the searching for a quarter-pixel MV, when the sum of absolute differences (SAD) of the half pixel are greater than the SAD of the chosen integer pixel, the chosen integer pixel is determined to be the half-pixel MV, and when the chosen integer pixel is determined to be the half-pixel MV, the quarter-pixel MV is searched for among eight quarter pixels neighboring the chosen integer pixel.

4. The MV search method of claim 1, wherein the half pixel corresponding to the half-pixel MV has a minimum sum of absolute differences (SAD) of the surrounding half-pixels, the SAD being computed by summing the absolute differences between the pixel values of current frame and a previous frame.

5. The MV search method of claim 1, wherein some of the half pixels are determined by a 6-tap finite impulse response filter.

6. A motion vector (MV) search method comprising:
searching for an integer-pixel MV among integer pixels and choosing an integer pixel corresponding to the integer-pixel MV;
searching for a half-pixel MV among half pixels around the chosen integer pixel and choosing a half pixel corresponding to the half-pixel MV; and
searching, when the half pixel is chosen, for a quarter-pixel MV among only quarter pixels disposed on a line connecting the chosen half pixel to the chosen integer pixel and choosing a quarter pixel corresponding to the quarter-pixel MV.

7. The MV search method of claim 6, further comprising searching for the quarter-pixel MV among the determined quarter pixel and quarter pixels disposed on a line orthogonal to the line which connects the chosen half pixel.

8. The MV search method of claim 7, wherein, in searching for the quarter-pixel MV among the determined quarter pixel and quarter pixels, the quarter-pixel MV is searched for among only the chosen quarter pixel and two quarter pixels disposed on the line orthogonal to the line which connects the chosen half pixel.

9. The MV search method of claim 6, wherein the chosen half pixel has a minimum sum of absolute differences (SAD) of the surrounding half-pixels, the SAD being computed by summing the absolute differences between the pixel values of current frame and a previous frame.

10. The MV search method of claim 6, wherein the chosen quarter pixel has the smaller a minimum sum of absolute differences (SAD) of the quarter pixels disposed on a line connecting the chosen half pixel to the chosen integer pixel.

11. A motion vector (MV) search method comprising:
searching for an integer-pixel MV among integer pixels and choosing an optimal integer pixel having a minimum sum of absolute differences (SAD) and a candidate integer pixel having a second-lowest SAD;
computing a median value of MVs of a current macroblock (MB) and adjacent MBs adjacent to the current MB and computing a predicted MV (PMV); and
searching, when a pixel corresponding to the computed PMV is identical to the chosen integer pixel, for a quarter-pixel MV among quarter pixels disposed between the optimal integer pixel and the candidate integer pixel and choosing a quarter pixel corresponding to the quarter-pixel MV,
wherein the SADs are computed by summing absolute differences between pixel values of a current frame and a previous frame.

12. The MV search method of claim 11, wherein the searching further comprises:
searching, when the pixel corresponding to the computed PMV is not identical to the optimal integer pixel, for a half-pixel MV among half pixels disposed between the optimal integer pixel and the candidate integer pixel and choosing the half pixel; and
searching for a quarter-pixel MV among only quarter pixels disposed in the direction toward the integer pixels from among quarter pixels neighboring the chosen half pixel.

13. The MV search method of claim 12, further comprising searching for the quarter-pixel MV among quarter pixels disposed in the direction toward the optimal integer pixel neighboring the determined half pixel and choosing the quarter pixel.

14. A motion vector (MV) search apparatus comprising:
an integer pixel search unit, which searches for an integer-pixel MV among integer pixels and chooses an integer pixel corresponding to the integer-pixel MV;
a half pixel search unit, which searches for a half-pixel MV among half pixels neighboring the chosen integer pixel and chooses an integer pixel corresponding to the integer-pixel MV; and
a quarter pixel search unit, which searches for a quarter-pixel MV among only quarter pixels disposed on a line which connects the chosen half pixel and the chosen integer pixel and chooses a quarter pixel corresponding to the quarter-pixel MV, when the half pixel is chosen.

15. The MV search apparatus of claim 14, wherein the quarter pixel search unit searches for the quarter-pixel MV among the chosen quarter pixel and quarter pixels disposed on a line orthogonal to the line which connects the chosen integer pixel and the chosen half pixel and chooses the quarter pixel.

16. The MV search apparatus of claim 14, wherein the quarter pixel search unit searches for the quarter-pixel MV among quarter pixels and chooses the quarter pixel according to whether the chosen integer pixel is identical to an integer pixel corresponding to a predicted MV (PMV), based on PMV of a current macroblock (MB).

17. A computer readable storage medium encoded with processing instructions for causing a computer to perform a motion vector (MV) search method comprising:
searching for an integer-pixel MV among integer pixels and choosing an integer pixel corresponding to the integer-pixel MV;
searching for a half-pixel MV among half pixels around the chosen integer pixel and choosing a half pixel corresponding to the half-pixel MV; and
searching, when the half pixel is chosen, for a quarter-pixel MV among only specified quarter pixels disposed between the chosen integer pixel and the chosen half pixel and around the chosen half pixel and choosing a quarter pixel corresponding to the quarter-pixel MV.

18. A computer readable storage medium encoded with processing instructions for causing a computer to perform a motion vector (MV) search method comprising:
searching for an integer-pixel MV among integer pixels and choosing an integer pixel corresponding to the integer-pixel MV;
searching for a half-pixel MV among half pixels around the chosen integer pixel and choosing a half pixel corresponding to the half-pixel MV; and
searching, when the half pixel is chosen, for a quarter-pixel MV among only quarter pixels disposed on a line connecting the chosen half pixel to the chosen integer pixel and choosing a quarter pixel corresponding to the quarter-pixel MV.

19. A computer readable storage medium encoded with processing instructions for causing a computer to perform a motion vector (MV) search method comprising:
searching for an integer-pixel MV among integer pixels and choosing an optimal integer pixel having a minimum sum of absolute differences (SAD) and a candidate integer pixel having a second-lowest SAD;
computing a median value of MVs of a current macroblock (MB) and adjacent MBs adjacent to the current MB and computing a predicted MV (PMV); and
searching, when a pixel corresponding to the computed PMV is identical to the chosen integer pixel, for a quarter-pixel MV among quarter pixels disposed between the optimal integer pixel and the candidate integer pixel and choosing a quarter pixel corresponding to the quarter-pixel MV,
wherein the SADs are computed by summing absolute differences between pixel values of a current frame and a previous frame.
